(19) United States
(12) Patent Application Publication
(10) Pub. No.: US 2006/0024141 A1
(43) Pub. Date: Feb. 2, 2006

(54) Power tool with an intermittent angular torque pulse

(75) Inventor: Hanspeter Schad, Grabs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/192,855

(22) Filed: Jul. 28, 2005

(30) Foreign Application Priority Data
Jul. 30, 2004 (DE) 10 2004 072.9

(51) Int. Cl. B23B 39/04

(52) U.S. Cl. 408/8

(57) ABSTRACT

A hand-held power tool includes a motor (6) for applying a drive torque (M_{A}) to the drive spindle (10) of the power tool, a working tool spindle (14) for driving a tool bit (18) in a rotational direction (D) and connectable with the drive spindle (10), an angular torque generator (12) for applying an angular torque pulse to the working tool spindle (14) when a resistance torque (M_{B}) acting on the working tool spindle (10) reaches a predetermined threshold, and a braking force generator (20) arranged on the working tool spindle (14) for applying thereto a braking force in a direction opposite the rotational direction of the working tool spindle.

### BACKGROUND OF THE INVENTION

1. Field of the Invention

The present invention relates to a hand-held power tool including a drive spindle, a motor for applying a drive torque to the drive spindle, a working tool spindle for driving a tool bit in a rotational direction and connectable with the drive spindle, a chuck for receiving the tool bit and connected with the working tool spindle for joint rotation therewith; an angular torque generator for applying an angular torque pulse to the working tool spindle when a resistance torque acting on the working tool spindle reaches a predetermined threshold.

2. Description of the Prior Art

Hand-held power tools of the type described above permit switching, during an operation, from a continuous rotation to an intermittent rotation as soon as a resistance torque, which is generated by braking forces acting on the working tool spindle and the chuck, reaches a predetermined threshold. During the intermittent rotation, very high recurrent angular torque pulses are applied to the working tool spindle, which easily overcome the resistance torque, and the power tool output can be noticeably increased.

German Publication DE-4328599 discloses a rotary-percussion tool in form of a rotary-percussion screwdriver. The tool has a hammer member. Ball elements connect the hammer member with the drive spindle and are displaceable in inclined grooves provided on both the hammer member and the drive spindle. The hammer member is provided with projections which abut, in the rotational direction, respective projections of the working tool spindle for transmitting a torque from the drive spindle to the working tool spindle. As soon as during driving a screw in, a resistance torque, which is generated as a result of a resistance force being transmitted from the driven-in screw to the working tool spindle, reaches a predetermined threshold, the hammer member is displaced over the inclined groove relative to the drive spindle and away from the working tool spindle until the hammer member projections disengage from the projection of the working tool spindle and move therepast. In the absence of resistance applied to the hammer member projections, the rotational speed of the hammer member increases. Further, as soon as the projections pass each other, the hammer member is accelerated in the direction toward the working tool spindle by a tension spring. In this way, the hammer member applies an axial press-on force to the working tool spindle, on one hand. On the other hand, the hammer member imparts, in the rotational direction, blows to the working tool spindle. The foregoing features permit to drive in screws in a workpiece against a high resistance torque because upon blows being applied to the projections of the working tool spindle by the hammer member, very high torques are generated.

German Publication DE-4344849 discloses a power tool that both at screw driving and core drilling, at a predetermined resistance torque, switches from a quasi-continuous rotational movement with a relatively small drive torque to an intermittent rotational movement with relatively high recurrent torque pulses. The power tool has an oscillating drive that is connected by an overrunning clutch with the chuck.

The drawback of the power tools, which are described above, consists in that they cannot be used, at least comfortably, for drilling bores in metal. The resistance torques, which are generated in the bore region during a normal drilling operation is not sufficient to recurrently actuate the angular torque generator. With a large press-on force applied to the rotary-percussion tool for pressing the tool against to-be-treated metal, the required threshold of the resistance torque can be overcome. Thereby, during drilling bores in metal, a noticeable increase in the output can be achieved only by applying very large forces to the power tool by the tool operator.

Accordingly, an object of the present invention is to eliminate the foregoing drawback in the power tool with an angular torque generator and to provide a power tool with which bore drilling can be comfortably carried out.

### SUMMARY OF THE INVENTION

This and other objects of the present invention, which will become apparent hereinafter, are achieved by arranging a braking force generator on the working tool spindle for applying thereto a braking force in a direction opposite the rotational direction of the working tool spindle.

By applying a braking force to the working tool spindle, it becomes possible to increase the resistance torque up to the necessary threshold at a very small external resistance torque acting on the working tool spindle or even in the absence of the external resistance torque. In this way, the angular torque generator can be activated at a very small or in absence of frictional resistance between the tool bit and a treated workpiece. In this way, conveniently, i.e., primarily without applying an increased press-on force to the power tool, a better output can be achieved, in particular, during drilling of bores in metals.

According to a particular advantageous embodiment of the present invention, the angular torque generator applies an axial force pulse to the working tool spindle. In this way, by using a braking force generator, automatically, a recurrent pulsing impact or press-on force can be generated in the axial direction of the working tool spindle, which is generated together with an angular torque. Thereby, an angular torque, which is transmitted to a tool bit formed, advantageously, as a twist drill bit, and which provides for machining a workpiece, is combined with a particularly high axial press-on force. As a result, a particularly good penetration of a drill bit in the workpiece is achieved, without a need for the power tool to be pressed against the workpiece by the tool operator. Also, as a result, predominantly, short metal chips are produced which are separated from the treated workpiece with each angular torque pulse and which can be rapidly transported away from the work region and which, therefore, apply only a small braking force to the tool bit. Thereby, a particularly good advancement of the tool bit in the metal becomes possible.

It is further particularly advantageous when the braking force generator is selectively turned on and off. Therefore, the hand-held power tool can be used, as needed, either for a tangential percussion screwdriving or for a rotary-percussion drilling. In this way, a tangential percussion screwdriver can be provided with an additional, selectively switchable, operational function.

Advantageously, the braking force generator has a sleeve-shaped support member through which the working tool spindle extends. Thereby, the braking force is circumferentially applied to the working tool spindle, which permits to generate a relatively large and uniform braking force.

Advantageously, a preloaded formlocking connection is formed between the working tool spindle and the support member of the braking force generator in the rotational direction of the working tool spindle. With a preloaded formlocking connection, a frictional connection, which is achieved with an element being preloaded against the outer surface of the working tool spindle, is increased as a result of a quasi-formlocking connection between the element and the outer surface. In order to avoid the deformation of the element and the outer surface, this quasi-formlocking connection is formed so that only a predetermined retaining force is produced. In this way, it is possible to apply to the working tool spindle a reliable and relatively high braking force, while simultaneously reducing the wear of the braking force generator.

It is advantageous when the formlocking connection is formed by a locking device arranged between the support member and the working tool spindle. The locking device includes a locking member radially displaceably supported against an element of one of the working tool spindle and the support member. The locking member is preloaded against an element of another of the working tool spindle and the support member. The element of the another of the working tool spindle and the support member is provided with at least one locking recess for receiving the locking member. In this way, a lasting, uniform braking force can be obtained with a braking force generator that can be produced with low manufacturing costs.

Advantageously, the locking recess is formed by a groove that extends transverse to the rotational direction. This insures a simple and cost-effective manufacturing of the locking device. Alternatively, the locking recess can be formed as a ramp-shaped recess having a spiral cross-section, with a depth of the ramp-shaped recess steadily diminishing in the rotational direction up to a shoulder which is formed by a ramp-shaped recess. Thereby, the locking member, upon being displaced from its first locking position to its second locking position, is almost completely pressed into the cross-bore in the working tool spindle and is displaced from the bore up to the next stop position also almost completely. This displacement of the locking member can prevent unnecessary noise generation.

According to a still further advantageous embodiment of the present invention, the locking recess is formed by a recess having an arch-shaped cross-section about the axis and a constant depth over its entire length in the rotational direction. Thereby, the locking member is located over the entire angular region of the arch-shaped recess in the same, maximally projecting position relative to the cross-bore of the working tool spindle. Therefore, the biasing force of the radial spring in this transition region remains minimal, so that the friction losses during displacement of the locking member from one locking position to another locking position are noticeably reduced.

It is further advantageous when the support member is axially displaceable between a braking position in which the locking member is arranged at an axial height of the locking recess, and a release position in which the locking member is arranged at a height of an annular groove extending in the rotational direction. In this way, the locking device can be actuated and deactuated in a simple manner. This permits to actuate and deactuate the braking force generator dependent on whether the power tool is used as a hammer drill or a tangential percussion screwdriver.

Alternatively or in addition, a frictional connection can be formed between the support member of the braking force generator and the working tool spindle. With the frictional connection, the braking force generator can be produced particularly cost-effectively and/or the generated braking force can be increased without a noticeable increase of the manufacturing costs.

Advantageously, the support member can be formed as a resilient friction ring, which permits to produce the braking force generator with particularly low manufacturing costs.

Advantageously, the threshold of the resistance torque lies within a range from 1 to 5 Nm. This range of resistance torques proved to be particularly suitable as it insures, on one hand, a good performance of the angular torque generator and can be reliably adjusted on the working tool spindle, with the use of the above-described braking force generator. On the other hand, the above-mentioned threshold values can be reliably exceeded by the drive torque of most of tangential percussion screwdrivers, so that a tangential percussion screwdriver with an additional percussive drilling function can be produced based on a series production of a conventional tangential percussion screwdriver.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side, partially cross-sectional view of a hand-held power tool according to the present invention;

FIG. 2 a longitudinal cross-sectional view of an angular torque generator and a braking force generator of the power tool shown in FIG. 1 in a free-running position;

FIG. 2 a longitudinal cross-sectional view of an angular torque generator and a braking force generator of the power tool shown in FIG. 1 in a braking position;

FIG. 4 a diagrammatic view showing characteristic curves of the torque and the axial force upon generation of the angular torque by the angular torque generator;

FIG. 5a a cross-sectional view of the braking force generator according to a first embodiment;

FIG. 5b a cross-sectional view of the braking force generator according to a second embodiment;

FIG. 5c a cross-sectional view of the braking force generator according to a third embodiment; and

FIG. 6 an exploded view of the angular torque generator and a frictional braking force generator.

### DETAILED DESCRIPTION OF THE PREFERRED EMBODIMENT

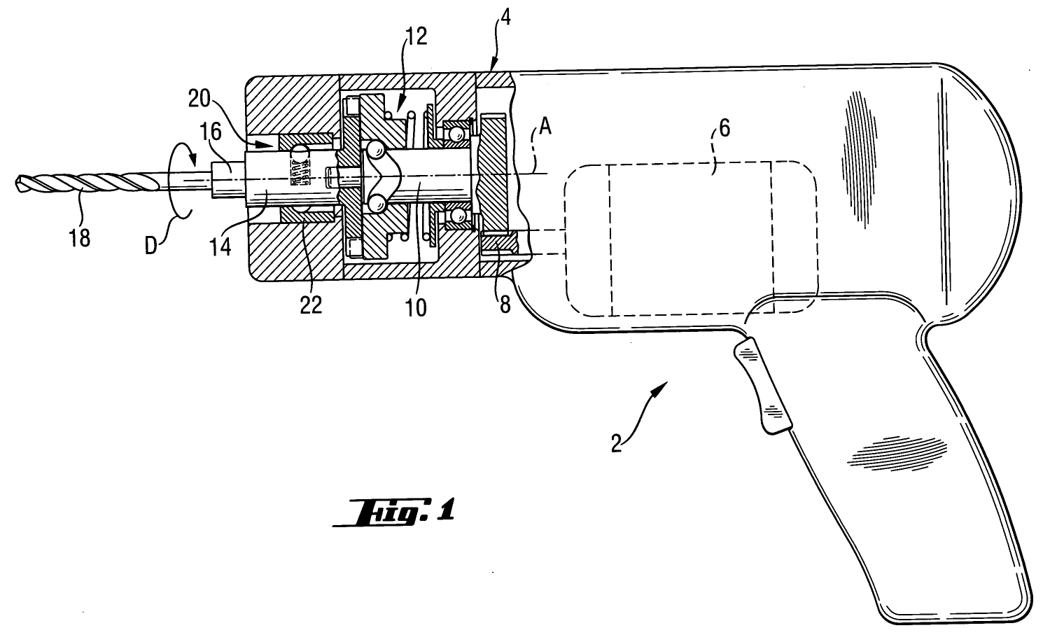

A hand-held power tool 2 according to the present invention, which is formed as a tangential percussion screwdriver and is shown in FIG. 1, has a housing 4 in which a universal motor 6 is located. The universal motor 6 drives, with its pinion 8, a drive spindle 10 in a rotational direction D about an axis A.

An angular torque generator, which is generally designated with a reference numeral 12, rotationally connects the drive spindle 10 with the drive spindle 14. A chuck 16, in which a working bit 18, e.g., formed as a screw bit or a drill bit, in particular, a twist drill bit can be received, is connected with the chuck 16 for joint rotation therewith.

A braking force generator, which is generally designated with a reference numeral 20, is provided on the working tool spindle 14. The braking force generator 20 applies to the working tool spindle 14 a braking force acting in a direction opposite the rotational direction D. The braking force generator 20 has a sleeve-shaped support member 22 through which the working tool spindle 14 extends.

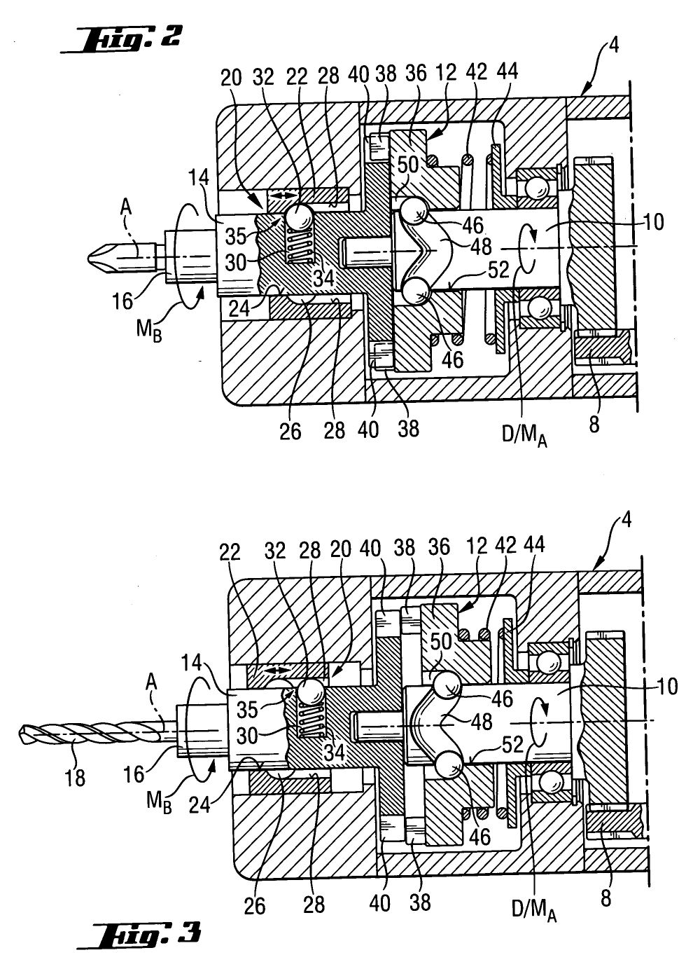

As particular shown in FIG. 2, the support member 22 is arranged in the housing 4 with a possibility of axial displacement relative thereto but without a possibility of rotation relative thereto. On the inner surface 24 of the support member 22, there are provided an annular groove 26, which extends transverse to the axis A and which surrounds the working tool spindle 14, and two locking recesses 28 which extend parallel to the axis A and which open into the annular groove 26.

In a position of the braking force generator 20 shown in FIG. 2, a ball-shaped locking member 32, which is radially displaceable in a cross-bore 30 of the working tool spindle 14, projects into the annular groove 26 of the support member 22. The locking member 32 is biased against the inner surface 24 of the support member 22 by a radial spring 34. The locking member 32, the annular groove 26, and the locking recesses 28 form together an on-off locking arrangement that is designated with a reference numeral 35.

As further shown in FIG. 2, the angular torque generator 12 has an impact member 36 which is provided with two impact projection 38 which project in a direction of the axis A. The impact projections 38 lie, in the rotational direction D, on working tool spindle projections 40 which project radially from the working spindle 14, as shown with dash lines.

The impact member 36 is biased in a direction of the working tool spindle 14 by an axial spring 42 which is supported against a support ring 44 fixedly connected with the drive spindle 10. The axial spring 42 has a spring rigidity from 10³ to 10⁵ N/m. Ball-shaped entraining elements 46 connect the impact member 36 with the drive spindle 10. The entraining elements 46 are displaced in a zigzag-shaped circumferential control groove 48 which is formed in the circumference of the drive spindle 10. Alternatively, a separate control groove 48, which extends only over a portion of the circumference of the drive spindle 10, can be provided for each entraining element 46. Simultaneously, the entraining elements 46 partially project in control recesses 50 formed in an axial bore 52 of the impact member 36.

When the universal motor 6 is turned on, a drive torque MA is transmitted from the drive spindle 10 to the entraining elements 46 which are biased by the axial spring 42 against the control groove 48 and against respective control recesses 50 in a fixed position. The entraining elements 46 remain in this position during rotation of the drive spindle 10 and transmit the drive torque M_{A} to the impact member 36. The impact projection 38 of the impact member 36 transmit the drive torque M_{A} to the spindle projections 40 of the working tool spindle 14 that transmits the drive torque M_{A} to the chuck 16.

The locking member 32 freely displaces in the annular groove 26, and the braking force generator 20 does not apply any noticeable braking force to the working tool spindle 14. In the position shown in FIG. 2, the braking force generator remains in a release position, which is suitable for driving a screw or a bolt (not shown) in a workpiece.

During a drive-in process, the tool bit 18 and the chuck 16 generate a resistance torque W_{B} which is applied to the working tool spindle 14 and which acts in a direction opposite the direction the drive torque M_{A} acts. As soon as the resistance torque M_{B} reaches its threshold that lies in a range from 1 to 5 N/m, the entraining member 46 cannot be further retained in its fixed position and is displaced, together with the impact member 36, along the control groove 48 away from the working tool spindle 14. The displacement path of the impact member 36 lies in a range between 5 and 20 mm. As a result, the impact projections 38 become disengaged from the working tool spindle projections 40, so that the impact projections 38 and spindle projection 40 are displaced over each other and past each other. Simultaneously, the action of the resistance torque M_{B} on the impact member 36 is interrupted.

As soon as the impact projections 38 pass respective spindle projection 40 on which they up to now rested, the axial spring 42 would bias the impact member 36 in the axial direction against the spindle projections 40. Simultaneously, the impact member 36 is accelerated in the rotational direction D along the control groove 48, and the impact projections 38 would impact respective other spindle projections 40.

In this way, a recurrent angular torque, which is generated by the angular torque generator 12, is transmitted to the working tool spindle 14 that, in turn, applies to the screw or bolt, which is being screwed-in, an intermittent torque from 5 to 300 N/m. Thus, with the power tool according to the present invention, screws and bolts can be screw-in or screw-out despite a high resistance torques M_{B}.

FIG. 3 shows the inventive power tool 2 in an percussion-rotary position that is particular suitable for drilling metals, e.g., steel. In this position, the support member 22 of the braking force generator 20 is axially displaced relative to the housing 4 to the extent that the locking member 32 is preloaded against the inner surface 24 of the support member 22 only at the height of both locking recesses 28.

Upon actuation of the universal motor 6 in this position of the support member 22, a drive torque is transmitted from the drive spindle 10 over the angular torque generator 12 to the working tool spindle 14. At that, the locking member 32 engages, as shown in FIG. 3, in one of the locking recesses 28. In this way, the braking force generator 20 occupies, as shown in FIG. 3, a braking position which is particularly suitable for drilling metal.

In the braking position, the formlocking engagement between the locking member 32 and the respective locking recess 28 provides for generation of a braking force in the direction opposite the rotational direction D. The braking force produces a resistance torque M_{B} from 1 to 5 Nm that acts on the working tool spindle 14. The generated resistance torque M_{B} is sufficient to insure displacement of the angular torque generator 12 into the above-described impact condition independent from out forces acting on the tool bit 18.

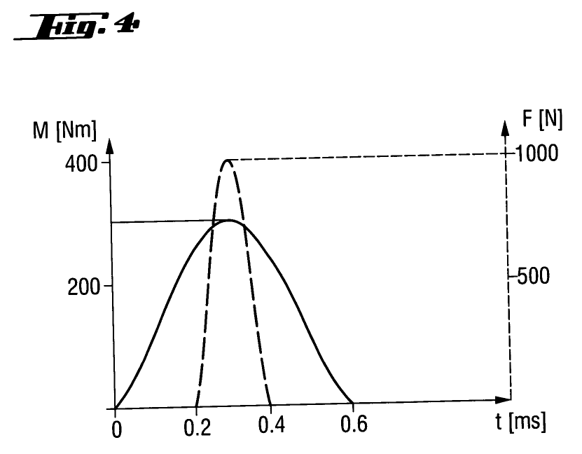

In this position of the angular force generator 12, the impact member 36, by being displaced in the axial direction, applies pressure to the tool bit 18, which if formed as a twist drill bit, pressing it against a to-be-drilled workpiece. During the press-on process, the impact projections 38 of the impact member 36 impact, in the rotational direction D, the spindle projection 40. As shown in diagram of FIG. 4, there is generated, in the rotational direction D, an intermittent torque M of 300 Nm simultaneously with a brief press-on force F of about 1 kN. This insures a particularly good penetration of the tool bit 18 in the workpiece, without a need to apply an increased press-on force by an operator of the power tool 2.

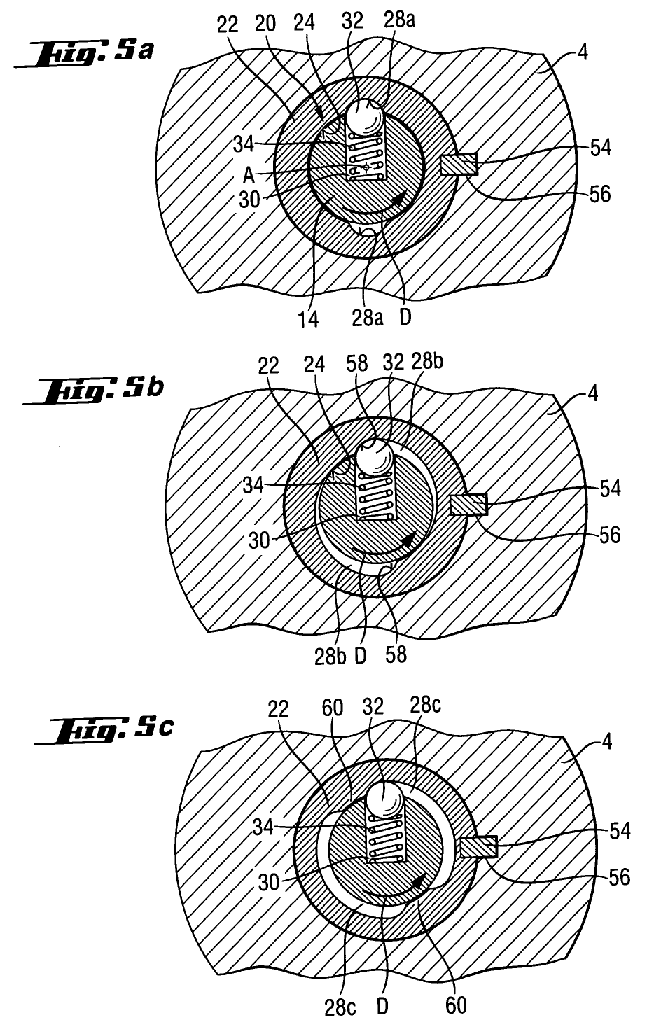

FIGS. 5a-5c show cross-sections of different embodiments of the braking force generator which distinguish from each other by different profiles of the locking recesses 28a, 28b, 28c.

The formlocking engagement of the locking member 32 in the respective locking recess 28 is first overcome by an angular torque which is generated by the angular torque generator 12. The locking member 32 is pressed against the radial spring 34 into the cross-bore 30, whereby the formlocking connection is released. In this way, the locking member 32 springs, during operation, from one locking recess 28 to another locking recess 28 with each angular torque pulse in the rotational direction.

In the embodiment shown in FIG. 5a, the locking recesses 28 are formed by two grooves 28a formed in the inner surface 24 of the support member 22. The grooves extend parallel to the axis A and are located opposite each other. During the operation, the locking member 32 forms, in the rotational direction D, a formlocking engagement with the stationary, non-rotatable, support member 22. During displacement of the locking member 32 from one locking recess 28a to another locking recess 28a, between these locking positions, the locking member 32 is almost completely pushed into the cross-bore 30.

In the embodiment shown in FIG. 5b, the locking recesses 28 are formed by two ramp-shaped recesses 28b which are formed in the inner surface 24 of the support member 22 and which have a spiral-shaped cross-section. The ramp-shaped recesses 28b form, in the rotational direction D, respective shoulders 58 that act as stops for the locking member 32. During the displacement of the locking member 32 between its locking positions, the locking member 32 is displaced along respective ramp-shaped recesses 28b gradually from the position, in which it is completely immersed in the cross-bore 30, to the engagement position, in which it is displaced out of the cross-bore 30 and engages against a respective shoulder 58.

In the embodiment shown in FIG. 5c, the locking recesses 28 are formed by two recesses 28c which are formed in the inner surface 24 of the support member 22 and which have an arch-shaped cross-section. The arch-shaped recesses form, in the rotational direction D, respective stop ribs 60 that act as stops for the locking member 32.

In this embodiment, it is insured that the locking member 32 applies as small as possible pressure force against the support member 22 as it is being displaced from one stop rib 60 to another stop rib 60.

In all three of the embodiments shown in FIGS. 5a-5c, the fixed connection of the support member 22 with the housing 4 is obtained by using a rib 54 that engages in a corresponding receptacle 56 formed in the housing 4.

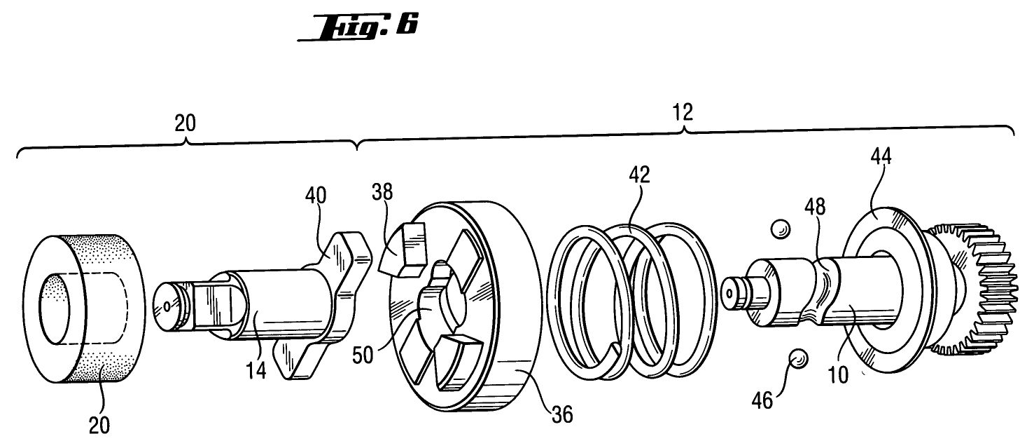

FIG. 6 shows an exploded view of the angular torque generator 12 with a further embodiment of the braking force generator 20. In the embodiment of the braking force generator 20 shown in FIG. 6, the support member 22 is formed by a resilient ring formed, e.g., of rubber or a plastic material. The resilient ring, as the support member in the previous embodiments, is fixedly secured in the housing 4 and generates, as a result of friction between the resilient ring and the outer surface of the working tool spindle 14, a resistance torque MB in order to actuate the angular torque generator 12.

In addition to the above-described different embodiments of the braking force generator 20, further embodiments can be envisaged. E.g., a controlled locking element, or a frictional connection, or a clamping member can provide a formlocking connection between the working tool spindle 14 and the housing 4. The control of the locking or clamping member can be effected, e.g., electromagnetically, piezoelectrically, electrostrictively, or magnetostrictively.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool (2), comprising:
a drive spindle (10);
a motor (6) for applying a drive torque (M_{A}) to the drive spindle (10);
a working tool spindle (14) for driving a tool bit (18) in a rotational direction (D) and connectable with the drive spindle (10);
a chuck (16) for receiving the tool bit (18) and connected with the working tool spindle (14) for joint rotation therewith;
an angular torque generator (12) for applying an angular torque pulse to the working tool spindle (14) when a resistance torque (M_{B}) acting on the working tool spindle (10) reaches a predetermined threshold; and
a braking force generator (20) arranged on the working tool spindle (14) for applying thereto a braking force in a direction opposite the rotational direction (D) of the working tool spindle (14).

2. A hand-held power tool according to claim 1, wherein the angular torque generator (12) comprises means for applying an axial force pulse to the working tool spindle (14).

3. A hand-held power tool according to claim 1, wherein the braking force generator (20) is selectively turned on and off.

4. A hand-held power tool according to claim 1, wherein the braking force generator (20) has a support member (22) fixedly secured in the tool housing (4) without a possibility of rotation relative thereto and through which the working tool spindle (14) extends.

5. A hand-held power tool according to claim 4, comprising means for forming a preloaded formlocking connection between the support member (22) and the working tool generator (14).

6. A hand-held power tool according to claim 5, wherein the formlocking connection forming means comprises locking means (35) having a locking member (32) radially displaceably supported against an element of one of the working tool spindle (14) and the support member (22) and preloaded against an element of another of the working tool spindle (14) and the support member (22), and wherein the element of the another of the working tool spindle (14) and the support member (22) is provided with at least one locking recess (28) for receiving the locking member (32).

7. A hand-held power tool according to claim 6, wherein the locking recess (28) is formed by a groove (28a) extending transverse to the rotational direction (2).

8. A hand-held power tool according to claim 6, wherein the locking recess (28) is formed as a ramp-shaped recess (28b) having a spiral cross-section, with a depth of the ramp-shaped recess (28b) steadily diminishing in the rotational direction (D) up to a shoulder (58) formed by the ramp-shaped recess (28b).

9. A hand-held power tool according to claim 6, wherein the locking recess (28) is formed by a recess (28c) having an arch-shaped cross-section about the axis (A) and a constant depth over an entire length thereof.

10. A hand-held power tool according to claim 6, wherein the support member (22) is axially displaceable between a braking position in which the locking member (32) is arranged at an axial height of the at least one locking recess (28), and a release position in which the locking member (32) is arranged at a height of an annular groove (26) extending in the rotational direction (D).

11. A hand-held power tool according to claim 4, comprising means for forming a frictional connection between the support member (22) and the working tool spindle (14).

12. A hand-held power tool according to claim 11, wherein the support member (22) is formed as a resilient friction ring.

13. A hand-held power tool according to claim 1, wherein the predetermined threshold of the resistance torque (M_{B}) lies in a range from 1 to 5 Nm.
